(19) United States
(12) Patent Application Publication
(10) Pub. No.: US 2016/0322630 A1
(43) Pub. Date: Nov. 3, 2016

(54) POSITIVE ELECTRODE MATERIAL FOR LITHIUM ION SECONDARY BATTERIES, POSITIVE ELECTRODE FOR LITHIUM ION SECONDARY BATTERIES, AND LITHIUM ION SECONDARY BATTERY

(71) Applicant: SUMITOMO OSAKA CEMENT CO., LTD., Tokyo (JP)

(72) Inventors: Masataka OYAMA, Yachiyo-shi (JP); Akinori YAMAZAKI, Narashino-shi (JP); Satoru OSHITARI, Funabashi-shi (JP); Ryuuta YAMAYA, Narashino-shi (JP); Takao KITAGAWA, Funabashi-shi (JP)

(21) Appl. No.: 14/946,484

(22) Filed: Nov. 19, 2015

(30) Foreign Application Priority Data
Apr. 30, 2015 (JP) 2015-093170

(51) Int. Cl. H01M 4/36; H01M 4/587; H01M 10/0525; H01M 4/58

(52) U.S. Cl. CPC H01M 4/366; H01M 4/5825; H01M 4/587; H01M 10/0525; H01M 2004/028

(57) ABSTRACT

A positive electrode material for lithium ion secondary batteries includes central particles composed of LiFeₓMn_{1-x-y}M_{y}PO₄ (0.05≦x≦1.0, 0≦y≦0.14, wherein M represents at least one element selected from Mg, Ca, Co, Sr, Ba, Ti, Zn, B, Al, Ga, In, Si, Ge, and rare earth elements), and a carbonaceous film that covers surfaces of the central particles, in which a specific magnetization is 0.70 emu/g or less, and an amount of water detected by a Karl Fischer titration method (coulometric titration method) in a temperature range of 100° C. or higher and 250° C. or lower is 8,000 ppm or less.

### BACKGROUND OF THE INVENTION

1. Field of the Invention

The present invention relates to a positive electrode material for lithium ion secondary batteries, a positive electrode for lithium ion secondary batteries, and a lithium ion secondary battery.

The present application claims priority on the basis of Japanese Patent Application No. 2015-093170, filed in Japan on Apr. 30, 2015; the content of which is incorporated herein by reference.

2. Description of Related Art

Studies have been underway to use secondary batteries for portable electronic devices and hybrid vehicles.

As representative examples of such secondary batteries, lead storage batteries, alkali storage batteries, and lithium ion batteries are known. Among various secondary batteries, lithium ion secondary batteries using lithium ions have advantages such as high output and high energy density.

As a positive electrode material used in lithium ion secondary batteries, a phosphate including Li and a transition metal and having an olivine structure is known (for example, refer to PCT Japanese Translation Patent Publication No. 2000-509193). For a method of producing such a phosphate, a production method through a synthesis method using a hydrothermal reaction (hydrothermal synthesis method) is known (for example, refer to Japanese Laid-open Patent Publication No. 2004-95385). In the hydrothermal synthesis method described in Japanese Laid-open Patent Publication No. 2004-95385, a phosphate composed of fine primary particles can be produced by increasing the hydrogen ion concentration (pH) of the reaction field. The primary particle refinement makes it possible to improve the diffusion rate of lithium ions into crystal grains and thus significantly contributes to achieve high input and output performance of a lithium ion secondary battery.

In the hydrothermal synthesis of a phosphate using iron and manganese, iron and manganese are easily oxidized in an aqueous solvent and impurities are formed by oxidation of iron and manganese during production of phosphate. In addition, when the hydrogen ion concentration (pH) of the reaction field at the time of the hydrothermal synthesis is increased, the oxidation of iron and manganese is accelerated and thus the amount of impurities further increases. It is difficult to remove impurities composed of oxides of the iron and manganese during the production step, and finally, the impurities remain in a product in the form of impurities having magnetic properties (hereinafter, also referred to as “magnetic impurities”) due to a change in the crystal structure due to the phosphate compound being subjected to a heat treatment in a step of forming a conductive carbon film. In the case in which magnetic impurities are included in the positive electrode material of the lithium ion secondary battery, there is a concern that the magnetic impurities may be eluted into an electrolyte. The magnetic impurities eluted into the electrolyte deteriorate durability by a breakage of a negative electrode SEI film by abrasion or cause a short circuit by breaking through a separator. Thus, it is desirable to prevent the impurities from entering the positive electrode material of the lithium ion secondary battery as much as possible.

Further, when the hydrogen ion concentration (pH) of the reaction field at the time of the hydrothermal synthesis is increased, due to a decrease in reactivity, a considerable amount of unreacted materials such as raw materials and intermediate products remains. It is known that A₃(PO₄)₂ (A represents either Fe or Mn), which is one unreacted material, includes water of crystallization (structural water). A₃(PO₄)₂ is obtained by removing water of crystallization (structural water) by a heat treatment. However, when A₃(PO₄)₂ is exposed to the atmosphere after the temperature is dropped, A₃(PO₄)₂ absorbs moisture in the atmosphere again. When this A₃(PO₄)₂ including water of crystallization (structural water) (hereinafter, also referred to as “water-containing impurities”) is present in the positive electrode material, there is a concern that battery cycle characteristics may be deteriorated with generation of gas resulting from decomposition of the water of crystallization (structural water) when a voltage is applied, and production of acid (for example, HF) resulting from a reaction between the water of crystallization (structural water) and the electrolyte in an electrode using the positive electrode material.

Since the acid produced from the water-containing impurities accelerates elution of the magnetic impurities into the electrolyte, it is desirable that the battery includes neither the magnetic impurities nor the water-containing impurities.

### SUMMARY OF THE INVENTION

The invention has been made in order to solve the above-described problems, and an object thereof is to provide a positive electrode material for lithium ion secondary batteries with reduced amounts of magnetic impurities and water-containing impurities, a positive electrode for lithium ion secondary batteries, and a lithium ion secondary battery.

As a result of thorough investigation for solving the above-described problems, the inventors of the present invention have found that when in a positive electrode material for lithium ion secondary batteries including central particles composed of LiFeₓMn_{1-x-y}M_{y}PO₄ (0.05≦x≦1.0, 0≦y≦0.14, wherein M represents at least one element selected from Mg, Ca, Co, Sr, Ba, Ti, Zn, B, Al, Ga, In, Si, Ge, and rare earth elements), and a carbonaceous film that covers the surfaces of the central particles, the specific magnetization is 0.70 emu/g or less, and the amount of water detected by a Karl Fischer titration method (coulometric titration method) in a temperature range of 100° C. or higher and 250° C. or lower is 8,000 ppm or less, it is possible to reduce the amounts of magnetic impurities and water-containing impurities, to improve durability and to prevent a short circuit from occurring. Thus, the invention has been completed.

According to an aspect of the invention, there is provided a positive electrode material for lithium ion secondary batteries comprising central particles composed of LiFeₓMn_{1-x-y}M_{y}PO₄ (0.05≦x≦1.0, 0≦y≦0.14, wherein M represents at least one element selected from Mg, Ca, Co, Sr, Ba, Ti, Zn, B, Al, Ga, In, Si, Ge, and rare earth elements), and a carbonaceous film that covers surfaces of the central particles, in which a specific magnetization is 0.70 emu/g or less, and an amount of water detected by a Karl Fischer titration method (coulometric titration method) in a temperature range of 100° C. or higher and 250° C. or lower is 8,000 ppm or less.

According to another aspect of the invention, there is provided a method of producing a positive electrode material for lithium ion secondary batteries comprising central particles expressed by LiFeₓMn_{1-x-y}M_{y}PO₄ (0.05≦x≦1.0, 0≦y≦0.14, wherein M represents at least one element selected from Mg, Ca, Co, Sr, Ba, Ti, Zn, B, Al, Ga, In, Si, Ge, and rare earth elements), the method comprising: obtaining a synthesized product which is a positive electrode active material or a precursor of the positive electrode active material by heating a dispersion obtained by dispersing at least a lithium salt, a metal salt including Fe, and a phosphoric acid compound selected from the group consisting of the lithium salt, the metal salt including Fe, a metal salt including Mn, and a compound including the M and the phosphoric acid compound, in a dispersion medium in a pressure resistant vessel; preparing a mixture by adding an auxiliary material including PO₄ and Li to the synthesized product; and firing the mixture, in which in the preparing of the mixture, a molar ratio of Li to PO₄ in the auxiliary material is 0.2 or more and 2.8 or less.

According to still another aspect of the invention, there is provided a positive electrode for lithium ion secondary batteries comprising a current collector, and a positive electrode mixture layer formed on the current collector, in which the positive electrode mixture layer contains the positive electrode material for lithium ion secondary batteries according to the aspect of the invention.

According to still another aspect of the invention, there is provided a lithium ion secondary battery comprising the positive electrode for lithium ion secondary batteries according to the aspect of the invention.

According to the positive electrode material for lithium ion secondary batteries of the invention, since the specific magnetization is 0.70 emu/g or less, and the amount of water detected by a Karl Fischer titration method (coulometric titration method) in a temperature range of 100° C. or higher and 250° C. or lower is 8,000 ppm or less, it is possible to obtain a lithium ion secondary battery with improved durability and safety.

According to the positive electrode for lithium ion secondary batteries of the invention, since the positive electrode comprises the positive electrode material for lithium ion secondary batteries of the invention, it is possible to obtain a lithium ion secondary battery with improved durability and safety.

According to the lithium ion secondary battery of the invention, since the lithium ion secondary battery includes the positive electrode for lithium ion secondary batteries of the invention, it is possible to obtain a lithium ion secondary battery with improved durability and safety.

### DETAILED DESCRIPTION OF THE INVENTION

Embodiments of a positive electrode material for lithium ion secondary batteries, a positive electrode for lithium ion secondary batteries, and a lithium ion secondary battery of the invention will be described.

These embodiments are merely specific examples for better understanding of the scope of the invention, and the invention is not limited thereto unless specified otherwise.

### Positive Electrode Material for Lithium Ion Secondary Batteries

### First Embodiment

A positive electrode material for lithium ion secondary batteries according to an embodiment comprises central particles composed of LiFeₓMn_{1-x-y}M_{y}PO₄ (0.05≦x≦1.0, 0≦y≦0.14, in which M represents at least one element selected from Mg, Ca, Co, Sr, Ba, Ti, Zn, B, Al, Ga, In, Si, Ge, and rare earth elements), and a carbonaceous film that covers the surfaces of the central particles, wherein the specific magnetization is 0.70 emu/g or less, and the amount of water detected by a Karl Fischer titration method (coulometric titration method) in a temperature range of 100° C. or higher and 250° C. or lower is 8,000 ppm or less.

The average primary particle diameter of the primary particles of the central particles composed of LiFeₓMn_{1-x-y}M_{y}PO₄ is preferably 0.001 μm or more and 5 μm or less, and more preferably 0.02 μm or more and 1 μm or less.

Here, the reason for limiting the average primary particle diameter of the primary particles of the central particles composed of LiFeₓMn_{1-x-y}M_{y}PO₄ to the above range is as follows. When the average primary particle diameter of the primary particles of the central particles composed of LiFeₓMn_{1-x-y}M_{y}PO₄ is less than 0.001 μm, it is difficult to sufficiently cover the surfaces of the primary particles of the central particles with the carbonaceous film, and the discharge capacity of a lithium ion secondary battery using the positive electrode material for lithium ion secondary batteries of the embodiment decreases in high-speed charging and discharging. Thus, it is difficult to realize sufficient charge and discharge performance. On the other hand, when the average primary particle diameter of the primary particles of the central particles composed of LiFeₓMn_{1-x-y}M_{y}PO₄ is more than 5 μm, the internal resistance of the primary particles of the central particles composed of LiFeₓMn_{1-x-y}M_{y}PO₄ increases and thus the lithium ion secondary battery using the positive electrode material for lithium ion secondary batteries of the embodiment has an insufficient discharge capacity in high-speed charging and discharging.

The average particle diameter of the embodiment refers to a volume average particle diameter. The average primary particle diameter of the primary particles of the central particles composed of LiFeₓMn_{1-x-y}M_{y}PO₄ can be measured by using a laser diffraction scattering type particle size distribution measuring device and the like. In addition, the average particle diameter can be calculated by selecting plural primary particles in an arbitrary manner among the primary particles observed with a scanning type electron microscope (SEM).

The shape of the primary particles of the central particles composed of LiFeₓMn_{1-x-y}M_{y}PO₄ is not particularly limited and since a positive electrode material composed of spherical secondary particles, particularly, perfectly spherical secondary particles is easily formed, the shape is preferably a spherical shape.

The reason why a spherical shape is preferable as the shape of the primary particles of the central particles composed of LiFeₓMn_{1-x-y}M_{y}PO₄ is as follows. When a positive electrode material paste for lithium ion secondary batteries is prepared by mixing a positive electrode material for lithium ion secondary batteries, a binder resin (binding agent), and a solvent, the amount of the solvent can be reduced and this positive electrode material paste for lithium ion secondary batteries can be easily applied to the current collector. In addition, when the shape of the primary particles of the central particles composed of LiFeₓMn_{1-x-y}M_{y}PO₄ is a spherical shape, the surface area of the primary particles of the central particles composed of LiFeₓMn_{1-x-y}M_{y}PO₄ becomes the minimum and the blending amount of the binder resin (binding agent) to be added to the positive electrode material paste for lithium ion secondary batteries can become the minimum. Thus, the internal resistance of a positive electrode to be obtained can be decreased. Further, when the shape of the primary particles of the central particles composed of LiFeₓMn_{1-x-y}M_{y}PO₄ is a spherical shape, it is easy to closely pack the electrode material, and thus the amount of the positive electrode material for lithium ion secondary batteries to be packed per unit volume increases. As a result, the electrode density can be increased and a lithium ion secondary battery with high capacity can be obtained.

The thickness of the carbonaceous film is preferably 0.2 nm or more and 10 nm or less.

The reason for limiting the thickness of the carbonaceous film to the above range is as follows. When the thickness is less than 0.2 nm, the thickness of the carbonaceous film is too small and thus a film having a desired resistance value cannot be formed. As a result, the conductivity decreases and sufficient conductivity as a positive electrode material cannot be secured. On the other hand, when the thickness of the carbonaceous film is more than 10 nm, battery activity, for example, the battery capacity per unit mass of the positive electrode material decreases.

In addition, the reason for limiting the thickness of the carbonaceous film to the above range is as follows. Due to easiness of close packing of the positive electrode material, the amount of the positive electrode material for lithium ion secondary batteries to be packed per unit volume increases and as a result, the electrode density can be increased and a lithium ion secondary battery with high capacity can be obtained.

The average particle diameter of the positive electrode material for lithium ion secondary batteries in which the surfaces of the primary particles of the central particles composed of LiFeₓMn_{1-x-y}M_{y}PO₄ are covered with the carbonaceous film is preferably 0.01 μm or more and 5 μm or less, and more preferably 0.02 μm or more and 1 μm or less.

Here, the reason for limiting the average particle diameter of the positive electrode material for lithium ion secondary batteries to the above range is as follows. When the average particle diameter of the positive electrode material for lithium ion secondary batteries is less than 0.01 μm, the mass of carbon required, when the specific surface area of carbonaceous electrode active material composite particles (positive electrode material for lithium ion secondary batteries) becomes larger, increases and the charge and discharge capacity of a lithium ion secondary battery using the positive electrode material for lithium ion secondary batteries of the embodiment decreases. On the other hand, when the average particle diameter of the positive electrode material for lithium ion secondary batteries is more than 5 μm, it takes some time for movement of lithium ions or movement of electrons in the carbonaceous electrode active material composite particles (positive electrode material for lithium ion secondary batteries). Accordingly, the internal resistance increases, and the output characteristics are deteriorated. Thus, this case is not preferable.

The amount of carbon included in the positive electrode material for lithium ion secondary batteries of the embodiment is preferably 0.1% by mass or more and 10% by mass or less, and more preferably 0.3% by mass or more and 3% by mass or less.

Here, the reason for limiting the amount of carbon included in the positive electrode material for lithium ion secondary batteries of the embodiment to the above range is as follows. When the amount of carbon is less than 0.1% by mass; the discharge capacity at a high-speed charge and discharge rate decreases in the case in which a battery is formed, and it is difficult to realize sufficient charge and discharge rate performance. On the other hand, when the amount of carbon included in the positive electrode material for lithium ion secondary batteries is more than 10% by mass; the electrode material contains an excessive amount of carbon, and the battery capacity of a lithium ion secondary battery per unit mass of the positive electrode material for lithium ion secondary batteries decreases more than necessary.

Further, the amount of carbon supported with respect to the specific surface area of the primary particles of the central particles composed of LiFeₓMn_{1-x-y}M_{y}PO₄ ([amount of carbon supported]/[specific surface area of primary particles of positive electrode active material]) is preferably 0.01 or more and 0.5 or less and more preferably 0.03 or more and 0.3 or less.

Here, the reason for limiting the amount of carbon supported with respect to the specific surface area of the primary particles of the central particles including LiFeₓMn_{1-x-y}M_{y}PO₄ to the above range is as follows. When the amount of carbon supported is less than 0.01; the discharge capacity at a high-speed charge and discharge rate decreases in the case in which a battery is formed, and it is difficult to realize sufficient charge and discharge rate performance. On the other hand, when the amount of carbon supported with respect to the specific surface area of the primary particles of the central particles including LiFeₓMn_{1-x-y}M_{y}PO₄ is more than 0.5, the electrode material contains an excessive mount of carbon and the battery capacity of a lithium ion secondary battery per unit mass of the primary particles of the central particles including LiFeₓMn_{1-x-y}M_{y}PO₄ decreases more than necessary.

In the positive electrode material for lithium ion secondary batteries of the embodiment, the specific magnetization is 0.70 emu/g or less, preferably 0.50 emu/g or less, and more preferably 0.40 emu/g or less.

When the specific magnetization of the positive electrode material for lithium ion secondary batteries is 0.70 emu/g or less, the amount of impurities composed of oxides of transition metals is reduced in the positive electrode material for lithium ion secondary batteries and a lithium ion secondary battery using the positive electrode material for lithium ion secondary batteries retains a discharge capacity retention of 70% or more after 300 cycles. On the other hand, when the specific magnetization of the positive electrode material for lithium ion secondary batteries is more than 0.70 emu/g, the amount of impurities composed of oxides of transition metals increases in the positive electrode material for lithium ion secondary batteries and the discharge capacity retention of a lithium ion secondary battery using the positive electrode material for lithium ion secondary batteries after 300 cycles is less than 70%.

In the embodiment, the specific magnetization of the positive electrode material for lithium ion secondary batteries is calculated by putting 0.55 g of a sample into a dedicated measuring folder using a vibrating sample magnetometer (VSM, trade mane: VSM-OP01, manufactured by Hayama Inc.) and defining a magnetization per g at an applied magnetic field of 5 kOe as a specific magnetization. The temperature for measurement is set to room temperature and the frequency when vibration is applied is set to 80 Hz.

The amount of water in the positive electrode material for lithium ion secondary batteries of the embodiment detected by a Karl Fischer titration method (coulometric titration method) in a temperature range of 100° C. or higher and 250° C. or lower is 8,000 ppm or less, preferably 6, 000 ppm or less, and more preferably 4,000 ppm or less.

Here, the reason for limiting the amount of water in the positive electrode material for lithium ion secondary batteries of the embodiment to the above range is as follows. When the amount of water is more than 8,000 ppm, it is difficult to remove water in a water removal step when a battery is produced and also the safety and durability of the battery are remarkably deteriorated due to generation of gas or production of hydrofluoric acid derived from water in the battery.

The specific surface area of the positive electrode material for lithium ion secondary batteries of the embodiment is 7 m²/g or more and preferably 9 m²/g or more.

When the specific surface area is less than 7 m²/g, the particles of the positive electrode material for lithium ion secondary batteries are coarsened and the diffusion rate of lithium in the particles decreases. Thus, the battery characteristics of a lithium ion secondary battery using the positive electrode material for lithium ion secondary batteries are deteriorated.

### Method of Producing Positive Electrode Material for Lithium Ion Secondary Batteries

A method of producing a positive electrode material for lithium ion secondary batteries according to the embodiment is not particularly limited; and for example, a method comprising preparing a raw material slurry for the positive electrode material for lithium ion secondary batteries by putting a Li source, a P source, an Fe source, a Mn source, and a M source, and an organic compound into a solvent, and uniformly dispersing the components while stirring; allowing the raw material slurry to react under high temperature and high pressure conditions; obtaining a precursor of a positive electrode active material by allowing the raw material slurry to react under high temperature and high pressure conditions; obtaining a slurry mixture by dissolving or dispersing the precursor of a positive electrode active material, an organic compound, a lithium compound, and a phosphoric acid compound in a solvent; obtaining a granulated body by drying the slurry mixture; and firing the dried product in a non-oxidizing atmosphere can be used.

### Preparation of Raw Material Slurry

The Li source, the P source, the Fe source, the Mn source, and the M source are put into a solvent containing water as a main component such that the molar ratio (Li source:P source:Fe source:Mn source:M source), that is, the molar ratio of Li:P:Fe:Mn:M becomes 1 to 4:1:0 to 1.5:0 to 1.5:0 to 0.2 and the sources are stirred and mixed to prepare a raw material slurry.

When considering uniform mixing of the Li source, the P source, the Fe source, the Mn source, and the M source, a method in which the Li source, the P source, the Fe source, the Mn source, and the M source are each brought into an aqueous solution state once, and then these aqueous solutions are mixed is preferable.

Since the molar concentration of the Li source, the P source, the Fe source, the Mn source, and the M resource in the raw material slurry is high and it is necessary to obtain central particles including very fine LiFeₓMn_{1-x-y}M_{y}PO₄ with high crystallinity, the molar concentration thereof is preferably 1.1 mol/L or more and 2.2 mol/L or less.

Examples of the Li source include hydroxides such as lithium hydroxide (LiOH), lithium salts of inorganic acids such as lithium carbonate (Li₂CO₃), lithium chloride (LiCl), lithium nitrate (LiNO₃), lithium phosphate (Li₃PO₄), dilithium hydrogen phosphate (Li₂HPO₄), and lithium dihydrogen phosphate (LiH₂PO₄), lithium salts of organic acids such as lithium acetate (CH₃COOLi) and lithium oxalate (Li₂(COO)₂); and hydrates thereof. As the Li source, at least one selected from the group consisting of these compounds can be suitably used.

In addition, lithium phosphate (Li₃PO₄) can be used as the Li source and the P source.

As the P source, for example, at least one selected from phosphoric acids such as orthophosphoric acid (H₃PO₄) and metaphosphoric acid (HPO₃), and phosphates such as ammonium dihydrogen phosphate (NH₄H₂PO₄), diammonium hydrogen phosphate ((NH₄)₂HPO₄), ammonium phosphate ((NH₄)₃PO₄), lithium phosphate (Li₃PO₄), dilithium hydrogen phosphate (Li₂HPO₄), and lithium dihydrogen phosphate (LiH₂PO₄); and hydrates thereof can be suitably used.

As the Fe source, for example, iron compounds such as iron(II) chloride (FeCl₂), iron(II) sulfate (FeSO₄),and iron(II) acetate (Fe(CH3COO)₂); and hydrates thereof; and trivalent iron compounds such as iron(III) nitrate (Fe(NO₃)₃), iron(III) chloride (FeCl₃), and iron(III) citrate (FeC₆H₅O₇), and lithium iron phosphate can be suitably used.

As the Mn source, a Mn salt is preferable and examples of the Mn source include manganese(II) chloride (MnCl₂), manganese(II) sulfate (MnSO₄), manganese(II) nitrate (Mn(NO₃)₂), manganese(II) acetate (Mn(CH₃COO)₂); and hydrates thereof. As the Mn source, at least one selected from the group consisting of these compounds can be suitably used.

As the M source, at least one source material selected from Mg, Ca, Co, Sr, Ba, Ti, Zn, B, Al, Ga, In, Si, Ge, and rare earth elements can be used.

Examples of the Mg source include magnesium(II) chloride (MgCl₂), magnesium(II) sulfate (MgSO₄), magnesium(II) nitrate (Mg(NO₃)₂), magnesium(II) acetate (Mg(CH₃COO)₂); and hydrates thereof and at least one selected from the group consisting of these compounds can be suitably used.

Examples of the Ca source include calcium(II) chloride (CaCl2), calcium(II) sulfate (CaSO₄), calcium(II) nitrate (Ca(NO₃)₂), calcium(II) acetate (Ca(CH₃COO)₂); and hydrates thereof and at least one selected from the group consisting of these compounds can be suitably used.

As the Co source, a Co salt is preferable and examples of the Co source include cobalt(II) chloride (CoCl₂), cobalt(II) sulfate (CoSO₄), cobalt(II) nitrate (Co(NO₃)₂), cobalt(II) acetate (Co(CH₃COO)₂); and hydrates thereof. As the Co source, at least one selected from the group consisting of these compounds can be suitably used.

Examples of the Sr source include strontium carbonate (SrCo₃), strontium sulfate (SrSO₄), and strontium hydroxide (Sr(OH)₂) and at least one selected from the group consisting of these compounds can be suitably used.

Examples of the Ba source include barium(II) chloride (BaCl₂), barium(II) sulfate (BaSO₄), barium(II) nitrate (Ba(NO₃)₂), barium(II) acetate (Ba(CH₃COO)₂); and hydrates thereof and at least one selected from the group consisting of these compounds can be suitably used.

Examples of the Ti source include titanium chlorides (TiCl₄, TiCl₃, TiCl₂), titanium oxide (TiO); and hydrates thereof and at least one selected from the group consisting of these compounds can be suitably used.

As the Zn source, a Zn salt is preferable and examples of the Zn source include zinc(II) chloride (ZnCl₂), zinc(II) sulfate (ZnSO₄), zinc(II) nitrate (Zn(NO₃)₂), zinc(II) acetate (Zn(CH₃COO)₂); and hydrates thereof. As the Zn source, at least one selected from the group consisting of these compounds can be suitably used.

Examples of the B source include boron compounds such as chlorides, sulfates, nitrates, acetates, hydroxides, and oxides, and at least one selected from the group consisting of these compounds can be suitably used.

Examples of the Al source include aluminum compounds such as chlorides, sulfates, nitrates, acetates, and hydroxides, and at least one selected from the group consisting of these compounds can be suitably used.

Examples of the Ga source include gallium compounds such as chlorides, sulfates, nitrates, acetates, and hydroxides, and at least one selected from the group consisting of these compounds can be suitably used.

Examples of the In source include indium compounds such as chlorides, sulfates, nitrates, acetates, and hydroxides, and at least one selected from the group consisting of these compounds can be suitably used.

Examples of the Si source include sodium silicate, potassium silicate, silicon tetrachloride (SiCl₄), silicates, and organic silicon compounds, and at least one selected from the group consisting of these compounds can be suitably used.

Examples of the Ge source include germanium compounds such as chlorides, sulfates, nitrates, acetates, hydroxides, and oxides, and at least one selected from the group consisting of these compounds can be suitably used.

Examples of the rare earth element source include chlorides, sulfates, nitrates, acetates, hydroxides, and oxides of Sc, Y, La, Ce, Pr, Nd, Pm, Sm, Eu, Gd, Tb, Dy, Ho, Er, Tm, Yb, and Lu and at least one selected from the group consisting of these compounds can be suitably used.

### Preparation of Precursor of Positive Electrode Active Material

Next, the prepared raw material slurry is put into a pressure resistant vessel and heated to a predetermined temperature to allow the mixture to react for a predetermined period of time (hydrothermal reaction).

The reaction conditions are appropriately selected according to the type of solvent or a material to be synthesized. However, in the case of using water as the solvent, it is preferable that the heating temperature is set to 80° C. to 374° C. and the reaction time is set to 0.5 hours to 24 hours. At this time, the pressure is set to 0.1 MPa to 22 MPa. It is more preferable that the heating temperature is set to 100° C. to 350° C., and the reaction time is set to 0.5 hours to 5 hours. At this time, the pressure is set to 0.1 MPa to 17 MPa.

Thereafter, the reaction product obtained by dropping the temperature is washed with water and thus a precursor of a positive electrode active material is obtained.

### Preparation of Slurry Mixture

The blending ratio of an organic compound to the precursor of a positive electrode active material is preferably 0.15 parts by mass or more and 15 parts by mass or less, and more preferably 0.45 parts by mass or more and 4.5 parts by mass or less with respect to 100 parts by mass of the precursor of the electrode active material when the total amount of the organic compound is converted into an amount of carbon.

When the blending ratio of the organic compound in an equivalent carbon amount is less than 0.15 parts by mass, the coverage ratio of a carbonaceous film formed by subjecting the organic compound to a heat treatment on the surface of the electrode active material is 80% or less and discharge capacity with a high-speed charge and discharge rate when a battery is formed decreases and it is difficult to realize a sufficient charge and discharge rate performance. On the other hand, when the blending ratio of the organic compound in an equivalent carbon amount is more than 15 parts by mass, the blending ratio of the electrode active material becomes relatively small, the capacity of a battery decreases when the battery is formed, and the density of the electrode active material increases due to the excess carbonaceous film being supported on the electrode active material. Therefore, the electrode density decreases, and the battery capacity of lithium ion secondary batteries per unit volume drops to an unignorable extent.

In addition, in this operation, it is preferable to have such a blending ratio of the lithium compound that the molar ratio of Li to PO₄ becomes 0.2 or more and 2.8 or less. The blending ratio of the lithium compound is more preferably 0.4 or more and 2.0 or less and still more preferably 0.6 or more and 1.5 or less.

When the molar ratio of Li to PO₄ is less than 0.2, an excessive amount of PO₄ becomes P₂O₅ during heating and then absorbs water in the atmosphere after the temperature is dropped and remains in the positive electrode active material in the form of H₃PO₄. Thus, the rate characteristic or durability of a lithium ion secondary battery is easily deteriorated. On the other hand, when the molar ratio of Li to PO₄ is more than 2.8, lithium easily remains as a lithium salt that has an adverse influence on the battery characteristics of Li₂CO₃ or the like in a positive electrode active material, and the durability of a lithium ion secondary battery is easily deteriorated.

The amount of PO₄ added with respect to 100 parts by mass of the precursor of a positive electrode active material is preferably 0.2 parts by mass or more and 4 parts by mass or less, and more preferably 0.4 parts by mass or more and 2 parts by mass or less.

When the amount of PO₄ added with respect to 100 parts by mass of the precursor of a positive electrode active material is less than 0.2 parts by mass, an insufficient reaction between impurities composed of oxides of iron and manganese and water-containing impurities included in the precursor of a positive electrode active material occurs and magnetic impurities and water-containing impurities remain in a positive electrode active material. On the other hand, when the amount of PO₄ added with respect to 100 parts by mass of the precursor of a positive electrode active material is more than 4 parts by mass, there is a large amount of residues that cannot react with impurities composed of oxides of iron and manganese or water-containing impurities and the residues easily remain in the form of lithium carbonate or H₃PO₄. Thus, the durability of a lithium secondary battery is deteriorated. In addition, the battery capacity of a lithium ion secondary battery per unit mass of the positive electrode material for lithium ion secondary batteries decreases more than necessary.

Examples of the organic compound include polyvinyl alcohol, polyvinyl pyrrolidone, cellulose, starch, gelatin, carboxymethyl cellulose, methyl cellulose, hydroxymethyl cellulose, hydroxyethyl cellulose, polyacrylic acid, polystyrene sulfonic acid, polyacrylamide, polyvinyl acetate, glucose, fructose, galactose, mannose, maltose, sucrose, lactose, glycogen, pectin, alginic acid, glucomannan, chitin, hyaluronic acid, chondroitin, agarose, polyether and multivalent alcohols.

Examples of the multivalent alcohols include polyethylene glycol, polypropylene glycol, polyglycerin, and glycerin.

Examples of the Li source include hydroxides such as lithium hydroxide (LiOH), and lithium organic acid salts such as lithium carbonate (Li₂CO₃), lithium chloride (LiCl), lithium nitrate (LiNO₃), lithium acetate (CH₃COOLi), and lithium oxalate (Li₂(COO)₂), and hydrates thereof. As the Li source, at least one selected from the group consisting of these compounds is suitably used.

As the P source, for example, at least one selected from the group consisting of phosphoric acids such as orthophosphoric acid (H₃PO₄), and metaphosphoric acid (HPO₃), and phosphates such as ammonium dihydrogen phosphate (NH₄H₂PO₄), diammonium hydrogen phosphate ((NH₄)₂HPO₄), and ammonium phosphate ((NH₄)₃PO₄); and hydrates thereof can be suitably used.

As the lithium phosphate source, for example, at least one selected from the group consisting of lithium inorganic acid salts such as lithium phosphate (Li₃PO₄), dilithium hydrogen phosphate (Li2HPO₄); and hydrates thereof can be suitably used.

As a solvent for dissolving or dispersing the precursor of a positive electrode active material, the organic compound, the lithium compound, and the phosphoric acid compound, water is preferable. However, in addition to water, examples of the solvent include alcohols such as methanol, ethanol, 1-propanol, 2-propanol (isopropyl alcohol: IPA), butanol, pentanol, hexanol, octanol, and diacetone alcohol; esters such as ethyl acetate, butyl acetate, ethyl lactate, propylene glycol monomethyl ether acetate, propylene glycol monoethyl ether acetate, and γ-butyrolactone; ethers such as diethyl ether, ethylene glycol monomethyl ether (methyl cellosolve), ethylene glycol monoethyl ether (ethyl cellosolve), ethylene glycol monobutyl ether (butyl cellosolve), diethylene glycol monomethyl ether, and diethylene glycol monoethyl ether; ketones such as acetone, methyl ethyl ketone (MEK), methyl isobutyl ketone (MIBK), acetylacetone, and cyclohexanone; amides such as dimethyl formamide, N,N-dimethyl acetoacetamide, and N-methyl pyrrolidone; and glycols such as ethylene glycol, diethylene glycol, and propylene glycol. These solvents may be used alone or a mixture of two or more solvents may be used.

When the raw material slurry is adjusted, a dispersing agent may be added as necessary.

As a method of dispersing the precursor of a positive electrode active material, the organic compound, the lithium compound, and the phosphoric acid compound in the solvent, a method is not particularly limited as long as the method is a method of uniformly dispersing the precursor of a positive electrode active material and dissolving and dispersing the organic compound, the lithium compound, and the phosphoric acid compound. As such a dispersion method, for example, a method using a medium stirring type dispersing apparatus that can stir medium particles at a high speed, such as a planetary ball mill, a vibrating ball mill, a beads mill, a paint shaker, an attritor and the like, is preferable.

### Production of Granulated Body

Next, using a spray pyrolysis method, the raw material slurry is sprayed and dried in a high temperature atmosphere, for example, in the atmosphere at a temperature of 110° C. or higher and 200° C. or less so as to produce a granulated body.

In the spray pyrolysis method, in order to produce an approximately spherical granulated body through rapid drying, the particle diameter of liquid droplets when spraying is preferably 0.01 μm or more and 100 μm or less.

### Firing of Granulated Body

Next, the granulated body is subjected to a heat treatment in an inert gas atmosphere or a reducing atmosphere. The heat treatment temperature is preferably 500° C. or higher and 900° C. or lower, and more preferably 600° C. or higher and 800° C. or lower.

The inert atmosphere is preferably an atmosphere filled with an inert gas such as nitrogen (N₂) or argon (Ar), and in the case in which it is necessary to further suppress oxidation of the granulated body, a reducing atmosphere containing a reducing gas such as hydrogen (H₂) is preferable.

Here, the reason for setting the heat treatment temperature to 500° C. or higher and 900° C. or less is as follows. When the heat treatment temperature is lower than 500° C., the decomposition and reaction of the organic compound does not sufficiently proceed, and the organic compound is insufficiently carbonized; as a result, an organic matter decomposition product having high resistance is generated as a decomposition and reaction product, which is not preferable. On the other hand, when the heat treatment temperature is higher than 900° C., components constituting a positive electrode active material, for example, lithium (Li) are vaporized, which leads to not only the occurrence of compositional deviation, but also the acceleration of the grain growth of a positive electrode active material. Therefore, the discharge capacity at a high-speed charge and discharge rate when a battery is formed decreases, and thus it is difficult to realize sufficient charge and discharge rate performance.

The heat treatment time is not particularly limited as long as the organic compound is sufficiently carbonized and is set to, for example, 0.01 hours or longer and 20 hours or shorter.

When the precursor of a positive electrode active material is included in the granulated body, the precursor of a positive electrode active material becomes a positive electrode active material. On the other hand, the organic compound is subjected to decomposition and reaction at the time of the heat treatment to produce carbon and this carbon adheres to the surface of the positive electrode active material to forma carbonaceous film. Thus, the surface of the positive electrode active material is covered with the carbonaceous film.

Here, in the case in which the positive electrode active material includes lithium as a constituent component, as the heat treatment time increases, lithium diffuses from the positive electrode active material to the carbonaceous film and is present in the carbonaceous film so that the conductivity of the carbonaceous film is further improved, which is preferable.

However, when the heat treatment time is excessively increased, a positive electrode active material in which abnormal grain growth occurs or a part of lithium is defective is formed and thus the performance of the electrode active material itself is deteriorated. As a result, this leads to deterioration in the characteristics of a battery using the electrode active material.

### Positive Electrode for Lithium Ion Secondary Batteries

A positive electrode for lithium ion secondary batteries of the embodiment includes a current collector, and an electrode mixture layer (electrode) formed on the current collector, and the electrode mixture layer includes the positive electrode material for lithium ion secondary batteries of the embodiment.

That is, the electrode for lithium ion secondary batteries of the embodiment is obtained by forming the electrode mixture layer on one main surface of the current collector using the positive electrode material for lithium ion secondary batteries of the embodiment.

The electrode for lithium ion secondary batteries of the embodiment is mainly used as an electrode for lithiumion secondary batteries.

A method of producing the electrode for lithium ion secondary batteries of the embodiment is not particularly limited and any method can be used as long as an electrode can be formed on the one main surface of the current collector using the positive electrode material for lithium ion secondary batteries of the embodiment by the method. As the method of producing the electrode for lithium ion secondary batteries of the embodiment, for example, the following method can be used.

First, a positive electrode material paste for lithium ion secondary batteries is prepared by mixing the positive electrode material for lithium ion secondary batteries of the embodiment, a binding agent, and a solvent.

In addition, a conductive auxiliary agent may be added to the positive electrode material for lithium ion secondary batteries of the embodiment as necessary.

### Binding Agent

As the binding agent, that is, the binder resin, for example, polytetrafluoroethylene (PTFE) resin, polyvinylidene fluoride (PVdF) resin, fluorine rubber and the like can be suitably used.

The blending ratio of the binder resin to the positive electrode material for lithium ion secondary batteries of the embodiment is not particularly limited and for example, the amount of the binding agent is preferably 1 part by mass or more and 30 parts by mass or less, and more preferably 3 parts by mass or more and 20 parts by mass or less with respect to 100 parts by mass of the positive electrode material for lithium ion secondary batteries.

Here, the reason for limiting the blending ratio of the binder resin to the positive electrode material for lithium ion secondary batteries to the above range is as follows. When the blending ratio of the binding agent is less than 1 part by mass, in the case in which a battery is formed using the positive electrode material paste for lithium ion secondary batteries including the positive electrode material for lithium ion secondary batteries of the embodiment, the adhesiveness between the electrode mixture layer and the current collector is not sufficient, and at the time of forming the electrode mixture layer by rolling and the like, the electrode mixture layer cracks or detaches, which is not preferable. In addition, in the battery charge and discharge process, there is a case in which the electrode mixture layer peels off from the current collector and the battery capacity or the charge and discharge rate decreases, which is not preferable. On the other hand, when the blending ratio of the binding agent is more than 30 parts by mass, there is a case in which the internal resistance of the positive electrode material for lithium ion secondary batteries increases and the battery capacity at a high-speed charge and discharge rate decreases, which is not preferable.

### Conductive Auxiliary Agent

The conductive auxiliary agent is not particularly limited and for example, at least one selected from the group consisting of fibrous carbon such as acetylene black, kitchen black, furnace black, vapor-phase grown carbon fibers (VGCF), carbon nanotubes, and the like can be used.

### Solvent

A solvent is appropriately added to the positive electrode material paste for lithium ion secondary batteries including the positive electrode material for lithium ion secondary batteries of the embodiment for easy application to an object to be coated such as a current collector.

Examples of the solvent include water; alcohols such as methanol, ethanol, 1-propanol, 2-propanol (isopropyl alcohol: IPA), butanol, pentanol, hexanol, octanol, and diacetone alcohol; esters such as ethyl acetate, butyl acetate, ethyl lactate, propylene glycol monomethyl ether acetate, propylene glycol monoethyl ether acetate, and γ-butyrolactone, ethers such as diethyl ether, ethylene glycol monomethyl ether (methyl cellosolve), ethylene glycol monoethyl ether (ethyl cellosolve), ethylene glycol monobutyl ether (butyl cellosolve), diethylene glycol monomethyl ether, and diethylene glycol monoethyl ether; ketones such as acetone, methyl ethyl ketone (MEK), methyl isobutyl ketone (MIBK), acetylacetone, and cyclohexanone; amides such as dimethyl formamide, N,N-dimethyl acetoacetamide, and N-methyl pyrrolidone; and glycols such as ethylene glycol, diethylene glycol, and propylene glycol. These solvents maybe used alone or a mixture of two or more solvents may be used.

The content of the solvent in the positive electrode material paste for lithium ion secondary batteries is preferably 50% by mass or more and 70% by mass or less, and more preferably 55% by mass or more and 65% by mass or less when the total amount of the positive electrode material for lithium ion secondary batteries, the binding agent, and the solvent is 100% by mass.

When the content of the solvent is within the above range, it is possible to obtain a positive electrode material paste for lithium ion secondary batteries having excellent electrode formability and battery characteristics.

A method of mixing the positive electrode material for lithium ion secondary batteries, the binding agent, the conductive auxiliary agent, and the solvent is not particularly limited and any method can be used as long as these components can be mixed uniformly. Examples thereof include methods using kneaders such as a ball mill, a sand mill, a planetary mixer, a paint shaker, and a homogenizer.

Next, the positive electrode material paste for lithium ion secondary batteries is applied to one main surface of the current collector to form a coating film. The coating film is dried and then attached to the surface through pressure and thus an electrode for lithium ion secondary batteries in which an electrode mixture layer is formed on one main surface of the current collector can be obtained.

### Lithium Ion Secondary Battery

The lithium ion secondary battery of the embodiment includes the electrode for lithium ion secondary batteries of the embodiment as a positive electrode, a negative electrode, a separator, and an electrolyte.

In the lithium ion secondary battery of the embodiment, the negative electrode, the electrolyte, the separator and the like are not particularly limited.

### Negative Electrode

For the negative electrode, for example, negative electrode materials such as metallic Li, carbon materials, Li alloys, and Li₄Ti₅O₁₂ can be used.

### Electrolyte

The electrolyte can be prepared by, for example, mixing ethylene carbonate (EC) and ethyl methyl carbonate (EMC) at a volume ratio of 1:1 to obtain a mixed solvent and dissolving lithium hexafluorophosphate (LiPF₆) in the mixed solvent at a concentration of, for example, 1 mol/dm³.

### Separator

For the separator, for example, porous propylene can be used.

In addition, instead of the electrolyte and the separator, a solid electrolyte may be used.

Since the electrode for lithium ion secondary batteries of the embodiment is used as a positive electrode in the lithium ion secondary battery of the embodiment, the electrode has high capacity and high energy density.

As described above, according to the positive electrode material for lithium ion secondary batteries of the embodiment, since the specific magnetization is 0.70 emu/g or less and the amount of water detected by a Karl Fischer titration method (coulometric titration method) in a temperature range of 100° C. or higher and 250° C. or lower is 8,000 ppm or less, it is possible to obtain a lithiumion secondary battery with improved durability and safety.

According to the electrode for lithium ion secondary batteries of the embodiment, since the electrode contains the positive electrode material for lithium ion secondary batteries of the embodiment, it is possible to obtain a lithium ion secondary battery with improved durability and safety.

According to the lithium ion secondary battery of the embodiment, since the lithium ion secondary battery includes the positive electrode for lithium ion secondary batteries of the embodiment, it is possible to obtain a lithium ion secondary battery with improved durability and safety.

### EXAMPLES

Hereinafter, the invention will be more specifically described using Examples and Comparative Examples, but the invention is not limited to the following examples.

### Example 1

### Synthesis of Positive Electrode Material for Lithium Ion Secondary Batteries

2 mol of Lithium phosphate (Li₃PO₄) and 2 mol of iron(II) sulfate (FeSO₄) were mixed with 2 L of water such that the total amount was 4 L. Thus, a uniform slurry mixture was prepared.

Next, this mixture was put into a pressure resistant sealed vessel having a volume of 8 L, followed by hydrothermal synthesis at 180° C. for 1 hour. Thus, a precipitate was formed.

Next, the precipitate was washed with water to obtain a cake-like precursor of a positive electrode active material.

Subsequently, 5.5 g of polyethylene glycol and 1.64 g of LiH₂PO₄ as organic compounds, and 500 g of zirconia balls with a diameter of 5 mm as medium particles were mixed with 150 g (solid state-converted) of the precursor of a positive electrode active material and then dispersed by a ball mill for 12 hours. Thus, a uniform slurry was prepared.

Next, the slurry was sprayed and dried in the atmosphere at 180° C. to obtain a granulated body composed of LiFePO₄ coated with an organic compound having an average particle diameter of 6 μm.

The obtained granulated body was fired in a non-oxidizing gas atmosphere at 700° C. for 1 hour, and then held at 40° C. for 30 minutes to obtain a positive electrode material for lithium ion secondary batteries of Example 1 (positive electrode material A1).

### Preparation of Lithium Ion Secondary Battery

To N-methyl-2-pyrrolidinone (NMP) as a solvent, the positive electrode material A1, polyvinylidene fluoride (PVdF) as a binding agent, and acetylene black (AB) as a conductive auxiliary agent were added such that the mass ratio in the paste was positive electrode material (A1):AB:PVdF=90:5:5. These components were mixed to prepare a positive electrode material paste.

Next, the positive electrode material paste was applied to the surface of an aluminum foil (current collector) having a thickness of 30 μm to form a coating film. This coating film was dried to form a positive electrode mixture layer on the surface of the aluminum foil. Then, the positive electrode mixture layer was pressurized with a predetermined pressure so as to have a predetermined density to prepare a positive electrode of Example 1.

Next, this positive electrode was punched out using a molding machine and a disk-shaped hole having a diameter of 16 mm was made. After it was dried under vacuum, a lithium ion secondary battery of Example 1 was prepared using a stainless steel (SUS) 2016 coin type cell under a dried argon atmosphere.

Metallic lithium was used as a negative electrode, a porous polypropylene film was used as a separator, and a 1 MLiPF₆ solution was used as an electrolyte. As the LiPF₆ solution, a mixed solution obtained by mixing ethylene carbonate and ethyl methyl carbonate at a volume ratio of 1:1 was used.

### Evaluation of Positive Electrode Material for Lithium Ion Secondary Batteries

### (1) Specific Magnetization

The specific magnetization of the positive electrode material was calculated by putting 0.55 g of a sample into a dedicated measuring folder using a vibrating sample magnetometer (VSM, trade name: VSM-OP01, manufactured by Hayama Inc.) and defining a magnetization per g at an applied magnetic field of 5 kOe as a specific magnetization. The temperature for measurement was set to room temperature and the frequency when vibration was applied was set to 80 Hz.

The results are shown in Table 1.

### (2) Amount of Water

The positive electrode material was dried in a vacuum atmosphere at 100° C. for 24 hours and water adsorbed to the surface of the positive electrode material was sufficiently removed.

Next, the dried positive electrode material was used to measure the amount of water detected using a Karl Fischer moisture meter (trade name: CA-200/VA-200, Mitsubishi Chemical Analytech Co., Ltd.) in the positive electrode material for lithium ion secondary batteries in a range of 100° C. to 250° C.

The results are shown in Table 1.

### Evaluation of Lithium Ion Secondary Battery

### (1) Battery Characteristics

The battery having carbon as a negative electrode was charged with constant current having a current value of 2 C at an environmental temperature of 60° C. until the charging voltage reached 4.5 V, and then when the charging was changed to constant voltage charging and the current value reached 0.01 C, the battery charging was ended. Then, the battery was discharged at a discharge rate of 2 C and when the battery voltage reached 3 V, the battery discharge was ended. At this time, the discharge capacity was measured and this value was set to an initial capacity.

Thereafter, charging and discharging were repeated under the aforementioned conditions and the discharge capacity at the 300th cycle was measured to calculate a discharge capacity retention with respect to the initial capacity.

The above results are shown in Table 1.

### Example 2

2 mol of Lithium phosphate (Li₃PO₄) and 2 mol of iron(II) sulfate (FeSO₄) were mixed with 2 L of water such that the total amount was 4 L. Thus, a uniform slurry mixture was prepared.

Next, this mixture was put into a pressure resistant sealed vessel having a volume of 8 L, followed by hydrothermal synthesis at 180° C. for 1 hour. Thus, a precipitate was formed.

Next, the precipitate was washed with water to obtain a cake-like precursor of a positive electrode active material.

Subsequently, 5.5 g of polyethylene glycol, 1.46 g of LiOH:H₂O and 4.13 g of an aqueous H₃PO₄ solution (75% by mass as

H₃PO₄) as organic compounds, and 500 g of zirconia balls with a diameter of 5 mm as medium particles were mixed with 150 g (solid state-converted) of the precursor of a positive electrode active material and then dispersed by a ball mill for 12 hours. Thus, a uniform slurry was prepared.

Hereinafter, a positive electrode material (A2) was obtained in the same manner as in Example 1.

The positive electrode material (A2) was evaluated in the same manner as in Example 1. The results are shown in Table 1.

In addition, a lithium ion secondary battery of Example 2 was prepared in the same manner as in Example 1 except that the positive electrode material (A2) was used.

The lithium ion secondary battery of Example 2 was evaluated in the same manner as in Example 1. The results are shown in Table 1.

### Example 3

2 mol of Lithium phosphate (Li₃PO₄) and 2 mol of iron(II) sulfate (FeSO₄) were mixed with 2 L of water such that the total amount was 4 L. Thus, a uniform slurry mixture was prepared.

Next, this mixture was put into a pressure resistant sealed vessel having a volume of 8 L, followed by hydrothermal synthesis at 180° C. for 1 hour. Thus, a precipitate was formed.

Next, the precipitate was washed with water to obtain a cake-like precursor of a positive electrode active material. Next, 5.5 g of polyethylene glycol, 8.58 g of CH₃COOLi.2H₂O and 6.9 g of (NH₃) H₂PO₄ as organic compounds, and 500 g of zirconia balls with a diameter of 5 mm as medium particles were mixed with 150 g (solid state-converted) of the precursor of a positive electrode active material and then dispersed by a ball mill for 12 hours. Thus, a uniform slurry was prepared.

Hereinafter, a positive electrode material (A3) was obtained in the same manner as in Example 1.

The positive electrode material (A3) was evaluated in the same manner as in Example 1. The results are shown in Table 1.

In addition, a lithium ion secondary battery of Example 3 was prepared in the same manner as in Example 1 except that the positive electrode material (A3) was used.

The lithium ion secondary battery of Example 3 was evaluated in the same manner as in Example 1. The results are shown in Table 1.

### Example 4

2 mol of Lithium phosphate (Li₃PO₄) and 2 mol of iron(II) sulfate (FeSO₄) were mixed with 2 L of water such that the total amount was 4 L. Thus, a uniform slurry mixture was prepared.

Next, this mixture was put into a pressure resistant sealed vessel having a volume of 8 L, followed by hydrothermal synthesis at 180° C. for 1 hour. Thus, a precipitate was formed.

Next, the precipitate was washed with water to obtain a cake-like precursor of a positive electrode active material.

Next, 5.5 g of polyethylene glycol, 0.38 g of LiOH.H₂O and 0.55 g of (NH₃)H₂PO₄ as organic compounds, and 500 g of zirconia balls with a diameter of 5 mm as medium particles were mixed with 150 g (solid state-converted) of the precursor of a positive electrode active material and then dispersed by a ball mill for 12 hours. Thus, a uniform slurry was prepared.

Hereinafter, a positive electrode material (A4) was obtained in the same manner as in Example 1.

The positive electrode material (A4) was evaluated in the same manner as in Example 1. The results are shown in Table 1.

In addition, a lithium ion secondary battery of Example 4 was prepared in the same manner as in Example 1 except that the positive electrode material (A4) was used.

The lithium ion secondary battery of Example 4 was evaluated in the same manner as in Example 1. The results are shown in Table 1.

### Example 5

2 mol of Lithium phosphate (Li₃PO₄) and 2 mol of iron(II) sulfate (FeSO₄) were mixed with 2 L of water such that the total amount was 4 L. Thus, a uniform slurry mixture was prepared.

Next, this mixture was put into a pressure resistant sealed vessel having a volume of 8 L, followed by hydrothermal synthesis at 180° C. for 1 hour. Thus, a precipitate was formed.

Next, the precipitate was washed with water to obtain a cake-like precursor of a positive electrode active material.

Next, 5.5 g of polyethylene glycol, 1.53 g of Li₃PO₄ and 0.34 g of an aqueous H₃PO₄ solution (75% by mass as H₃PO₄) as organic compounds, and 500 g of zirconia balls with a diameter of 5 mm as medium particles were mixed with 150 g (solid state-converted) of the precursor of a positive electrode active material and then dispersed by a ball mill for 12 hours. Thus, a uniform slurry was prepared.

Hereinafter, a positive electrode material (A5) was obtained in the same manner as in Example 1.

The positive electrode material of Examples 5 was evaluated in the same manner as in Example 1. The results are shown in Table 1.

### Example 6

2 mol of lithium phosphate (Li₃PO₄) and 2 mol of iron(II) sulfate (FeSO₄) were mixed with 2 L of water such that the total amount was 4 L. Thus, a uniform slurry mixture was prepared.

Next, this mixture was put into a pressure resistant sealed vessel having a volume of 8 L, followed by hydrothermal synthesis at 180° C. for 1 hour. Thus, a precipitate was formed.

Next, the precipitate was washed with water to obtain a cake-like precursor of a positive electrode active material.

Next, 5.5 g of polyethylene glycol, 0.49 g of LiH₂PO₄ and 1.27 g of (NH₃) H₂PO₄ as organic compounds, and 500 g of zirconia balls with a diameter of 5 mm as medium particles were mixed with 150 g (solid state-converted) of the precursor of a positive electrode active material and then dispersed by a ball mill for 12 hours. Thus, a uniform slurry was prepared.

Hereinafter, a positive electrode material (A6) was obtained in the same manner as in Example 1.

The positive electrode material of Examples 6 was evaluated in the same manner as in Example 1. The results are shown in Table 1.

### Example 7

2 mol of lithium phosphate (Li₃PO₄), 0.6 mol of iron(II) sulfate (FeSO₄), and 1.4 mol of manganese(II) sulfate (MnSO₄) were mixed with 2 L (liters) of water such that the total amount was 4 L. Thus, a uniform slurry mixture was prepared.

Next, this mixture was put into a pressure resistant sealed vessel having a volume of 8 L, followed by hydrothermal synthesis at 180° C. for 1 hour. Thus, a precipitate was formed.

Next, the precipitate was washed with water to obtain a cake-like precursor of a positive electrode active material.

Next, 5.5 g of polyethylene glycol, 1.15 g of LiH₂PO₄ and 0.62 g of an aqueous H₃PO₄ solution (75% by mass as H₃PO₄) as organic compounds, and 500 g of zirconia balls with a diameter of 5 mm as medium particles were mixed with 150 g (solid state-converted) of the precursor of a positive electrode active material and then dispersed by a ball mill for 12 hours. Thus, a uniform slurry was prepared.

Hereinafter, a positive electrode material (A7) was obtained in the same manner as in Example 1.

The positive electrode material (A7) was evaluated in the same manner as in Example 1. The results are shown in Table 1.

In addition, a lithium ion secondary battery of Example 7 was prepared in the same manner as in Example 1 except that the positive electrode material (A7) was used.

The lithium ion secondary battery of Example 7 was evaluated in the same manner as in Example 1. The results are shown in Table 1.

### Example 8

2 mol of lithium phosphate (Li₃PO₄), 0.58 mol of iron(II) sulfate (FeSO₄), 1.4 mol of manganese(II) sulfate (MnSO₄) and 0.02 mol of cobalt sulfate (CoSO₄) were mixed with 2 L (liters) of water such that the total amount was 4 L. Thus, a uniform slurry mixture was prepared.

Next, this mixture was put into a pressure resistant sealed vessel having a volume of 8 L, followed by hydrothermal synthesis at 180° C. for 1 hour. Thus, a precipitate was formed.

Next, the precipitate was washed with water to obtain a cake-like precursor of a positive electrode active material.

Next, 5.5 g of polyethylene glycol, 0.58 g of Li₂CO₃ and 2.06 g of an aqueous H₃PO₄ solution (75% by mass as H₃PO₄) as organic compounds, and 500 g of zirconia balls with a diameter of 5 mm as medium particles were mixed with 150 g (solid state-converted) of the precursor of a positive electrode active material and then dispersed by a ball mill for 12 hours. Thus, a uniform slurry was prepared.

Hereinafter, a positive electrode material (A8) was obtained in the same manner as in Example 1.

The positive electrode material (A8) was evaluated in the same manner as in Example 1. The results are shown in Table 1.

In addition, a lithium ion secondary battery of Example 8 was prepared in the same manner as in Example 1 except that the positive electrode material (A8) was used.

The lithium ion secondary battery of Example 8 was evaluated in the same manner as in Example 1. The results are shown in Table 1.

### Example 9

2 mol of lithium phosphate (Li₃PO₄), 0.58 mol of iron(II) sulfate (FeSO₄), 1.4 mol of manganese(II) sulfate (MnSO₄), and 0.02 mol of zinc sulfate (ZnSO₄) were mixed with 2 L (liters) of water such that the total amount was 4 L. Thus, a uniform slurry mixture was prepared.

Next, this mixture was put into a pressure resistant sealed vessel having a volume of 8 L, followed by hydrothermal synthesis at 180° C. for 1 hour. Thus, a precipitate was formed.

Next, the precipitate was washed with water to obtain a cake-like precursor of a positive electrode active material.

Next, 5.5 g of polyethylene glycol, 0.66 g of LiOH.H₂O and 0.97 g of CH₃COOLi.2H₂O, and 2.06 g of an aqueous H₃PO₄ solution (75% by mass as H₃PO₄) as organic compounds, and 500 g of zirconia balls with a diameter of 5 mm as medium particles were mixed with 150 g (solid state-converted) of the precursor of a positive electrode active material and then dispersed by a ball mill for 12 hours. Thus, a uniform slurry was prepared.

Hereinafter, a positive electrode material (A9) was obtained in the same manner as in Example 1.

The positive electrode material (A9) was evaluated in the same manner as in Example 1. The results are shown in Table 1.

In addition, a lithium ion secondary battery of Example 9 was prepared in the same manner as in Example 1 except that the positive electrode material (A9) was used.

The lithium ion secondary battery of Example 9 was evaluated in the same manner as in Example 1. The results are shown in Table 1.

### Example 10

2 mol of lithium phosphate (Li₃PO₄), 0.56 mol of iron(II) sulfate (FeSO₄), 1.4 mol of manganese(II) sulfate (MnSO₄), 0.02 mol of cobalt sulfate (CoSO₄) and 0.02 mol of zinc sulfate (ZnSO₄) were mixed with 2 L (liters) of water such that the total amount was 4 L. Thus, a uniform slurry mixture was prepared.

Next, this mixture was put into a pressure resistant sealed vessel having a volume of 8 L, followed by hydrothermal synthesis at 180° C. for 1 hour. Thus, a precipitate was formed.

Next, the precipitate was washed with water to obtain a cake-like precursor of a positive electrode active material.

Next, 5.5 g of polyethylene glycol, 0.66 g of LiOH.H₂O, 1.61 g of CH₃COOLi.2H₂O, 2.06 g of an aqueous H₃PO₄ solution (75% by mass as H₃PO₄) as organic compounds, and 500 g of zirconia balls with a diameter of 5 mm as medium particles were mixed with 150 g (solid state-converted) of the precursor of a positive electrode active material and then dispersed by a ball mill for 12 hours. Thus, a uniform slurry was prepared.

Hereinafter, a positive electrode material (A10) was obtained in the same manner as in Example 1.

The positive electrode material (A10) was evaluated in the same manner as in Example 1. The results are shown in Table 1.

In addition, a lithium ion secondary battery of Example 10 was prepared in the same manner as in Example 1 except that the positive electrode material (A10) was used.

The lithium ion secondary battery of Example 10 was evaluated in the same manner as in Example 1. The results are shown in Table 1.

### Comparative Example 1

2 mol of lithium phosphate (Li₃PO₄) and 2 mol of iron(II) sulfate (FeSO₄) were mixed with 2 L (liters) of water such that the total amount was 4 L (liters). Thus, a uniform slurry mixture was prepared.

Next, this mixture was put into a pressure resistant sealed vessel having a volume of 8 L, followed by hydrothermal synthesis at 180° C. for 1 hour. Thus, a precipitate was formed.

Next, the precipitate was washed with water to obtain a cake-like precursor of a positive electrode active material.

Next, 5.5 g of polyethylene glycol and 500 g of zirconia balls with a diameter of 5 mm as medium particles were mixed with 150 g (solid state-converted) of the precursor of a positive electrode active material and then dispersed by a ball mill for 12 hours. Thus, a uniform slurry was prepared.

Hereinafter, a positive electrode material (C1) was obtained in the same manner as in Example 1.

The positive electrode material (C1) was evaluated in the same manner as in Example 1. The results are shown in Table 1.

In addition, a lithium ion secondary battery of Comparative Example 1 was prepared in the same manner as in Example 1 except that the positive electrode material (C1) was used.

The lithium ion secondary battery of Comparative Example 1 was evaluated in the same manner as in Example 1. The results are shown in Table 1.

### Comparative Example 2

2 mol of lithium phosphate (Li₃PO₄) and 2 mol of iron(II) sulfate (FeSO₄) were mixed with 2 L (liters) of water such that the total amount was 4 L (liters). Thus, a uniform slurry mixture was prepared.

Next, this mixture was put into a pressure resistant sealed vessel having a volume of 8 L, followed by hydrothermal synthesis at 180° C. for 1 hour. Thus, a precipitate was formed.

Next, the precipitate was washed with water to obtain a cake-like precursor of a positive electrode active material.

Next, 5.5 g of polyethylene glycol and 0.246 g of LiH₂PO₄ as organic compounds, and 500 g of zirconia balls with a diameter of 5 mm as medium particles were mixed with 150 g (solid state-converted) of the precursor of a positive electrode active material and then dispersed by a ball mill for 12 hours. Thus, a uniform slurry was prepared.

Hereinafter, a positive electrode material (C2) was obtained in the same manner as in Example 1.

The positive electrode material (C2) was evaluated in the same manner as in Example 1. The results are shown in Table 1.

In addition, a lithium ion secondary battery of Comparative Example 2 was prepared in the same manner as in Example 1 except that the positive electrode material (C2) was used.

The lithium ion secondary battery of Comparative Example 2 was evaluated in the same manner as in Example 1. The results are shown in Table 1.

### Comparative Example 3

A positive electrode material (C3) was obtained in the same manner as in Comparative Example 2 except that the amount of LiH₂PO₄ added was changed to 7.38 g.

A positive electrode material (C3) was evaluated in the same manner as in Example 1. The results are shown in Table 1.

In addition, a lithium ion secondary battery of Comparative Example 3 was prepared in the same manner as in Example 1 except that the positive electrode material (C3) was used.

The lithium ion secondary battery of Comparative Example 3 was evaluated in the same manner as in Example 1. The results are shown in Table 1.

### Comparative Example 4

2 mol of lithium phosphate (Li₃PO₄) and 2 mol of iron(II) sulfate (FeSO₄) were mixed with 2 L (liters) of water such that the total amount was 4 L. Thus, a uniform slurry mixture was prepared.

Next, this mixture was put into a pressure resistant sealed vessel having a volume of 8 L, followed by hydrothermal synthesis at 180° C. for 1 hour. Thus, a precipitate was formed.

Next, the precipitate was washed with water to obtain a cake-like precursor of a positive electrode active material.

Next, 5.5 g of polyethylene glycol, 1.64 g of LiH₂PO₄ and 0.94 g of LiOH as organic compounds, and 500 g of zirconia balls with a diameter of 5 mm as medium particles were mixed with 150 g (solid state-converted) of the precursor of a positive electrode active material and then dispersed by a ball mill for 12 hours. Thus, a uniform slurry was prepared.

Hereinafter, a positive electrode material (C4) was obtained in the same manner as in Example 1.

A lithium ion secondary battery of Comparative Example 4 was evaluated in the same manner as in Example 1. The results are shown in Table 1.

### Comparative Example 5

2 mol of lithium phosphate (Li₃PO₄) and 2 mol of iron(II) sulfate (FeSO₄) were mixed with 2 L (liters) of water such that the total amount was 4 L. Thus, a uniform slurry mixture was prepared.

Next, this mixture was put into a pressure resistant sealed vessel having a volume of 8 L, followed by hydrothermal synthesis at 180° C. for 1 hour. Thus, a precipitate was formed.

Next, the precipitate was washed with water to obtain a cake-like precursor of a positive electrode active material.

Next, 5.5 g of polyethylene glycol, 0.11 g of LiH₂PO₄ and 1.08 g of (NH₃)H₂PO₄ as organic compounds, and 500 g of zirconia balls with a diameter of 5 mm as medium particles were mixed with 150 g (solid state-converted) of the precursor of a positive electrode active material and then dispersed by a ball mill for 12 hours. Thus, a uniform slurry was prepared.

Hereinafter, a positive electrode material (C5) was obtained in the same manner as in Example 1.

A lithium ion secondary battery of Comparative Example 5 was evaluated in the same manner as in Example 1. The results are shown in Table 1.

### Comparative Example 6

2 mol of lithium phosphate (Li₃PO₄), 0.6 mol of iron(II) sulfate (FeSO₄) and 1.4 mol of manganese(II) sulfate (MnSO₄) were mixed with 2 L (liters) of water such that the total amount was 4 L. Thus, a uniform slurry mixture was prepared.

Hereinafter, a positive electrode material (C6) was obtained in the same manner as in Comparative Example 1.

The positive electrode material (C6) was evaluated in the same manner as in Example 1. The results are shown in Table 1.

In addition, a lithium ion secondary battery of Comparative Example 6 was prepared in the same manner as in Example 1 except that the positive electrode material (C6) was used.

The lithium ion secondary battery of Comparative Example 6 was evaluated in the same manner as in Example 1. The results are shown in Table 1.

TABLE 1

| | | Amount | Amount | | | | |
|---|---|---|---|---|---|---|---|
| | Composition of | of Li | of PO₄ | | | | Discharge |
| | precursor of positive | added | added | Li/P | Specific | Amount | capacity |
| | electrode active | (% by | (% by | (molar | magnetization | of water | retention |
| | material | mass) | mass) | ratio) | (emu/g) | (ppm) | (%) |
| Example 1 | LiFeP0₄ | 0.073 | 1 | 1 | 0.34 | 3790 | 84 |
| Example 2 | LiFeP0₄ | 0.161 | 2 | 1.1 | 0.31 | 2984 | 81 |
| Example 3 | LiFeP0₄ | 0.389 | 3.8 | 1.4 | 0.29 | 2436 | 75 |
| Example 4 | LiFeP0₄ | 0.042 | 0.3 | 1.9 | 0.58 | 5421 | 73 |
| Example 5 | LiFeP0₄ | 0.183 | 1 | 2.5 | 0.34 | 2781 | 79 |
| Example 6 | LiFeP0₄ | 0.022 | 1 | 0.3 | 0.37 | 3957 | 76 |
| Example 7 | LiFe_{0.3}Mn_{0.7}P0₄ | 0.051 | 1 | 0.7 | 0.45 | 3923 | 86 |
| Example 8 | LiFe_{0.29}Mn_{0.7}Co_{0.01}P0₄ | 0.073 | 1 | 1 | 0.48 | 3760 | 85 |
| Example 9 | LiFe_{0.29}Mn_{0.7}Zn_{0.01}P0₄ | 0.117 | 1 | 1.6 | 0.47 | 3865 | 84 |
| Example 10 | LiFe_{0.28}Mn_{0.7}Co_{0.01}Zn_{0.01}P0₄ | 0.146 | 1 | 2 | 0.47 | 3548 | 87 |
| Comparative | LiFeP0₄ | 0 | 0 | — | 0.78 | 8280 | 63 |
| Example 1 | | | | | | | |
| Comparative | LiFeP0₄ | 0.011 | 0.15 | 1 | 0.71 | 7394 | 65 |
| Example 2 | | | | | | | |
| Comparative | LiFeP0₄ | 0.329 | 4.5 | 1 | 0.28 | 2398 | 67 |
| Example 3 | | | | | | | |
| Comparative | LiFeP0₄ | 0.256 | 1 | 3.5 | 0.34 | 2583 | 64 |
| Example 4 | | | | | | | |
| Comparative | LiFeP0₄ | 0.007 | 1 | 0.1 | 0.41 | 4387 | 66 |
| Example 5 | | | | | | | |
| Comparative | LiFe_{0.3}Mn_{0.7}P0₄ | 0 | 0 | — | 0.83 | 8463 | 65 |
| Example 6 | | | | | | | |

From the results of Table 1, it could be confirmed that when Examples 1 to 10 were compared to Comparative Examples 1 to 6, in the lithium ion secondary batteries of Examples 1 to 10, the capacity retention at the 300th cycle with respect to the initial capacity was 73% or more. On the other hand, it could be confirmed that in the lithium ion secondary batteries of Comparative Examples 1 to 6, the capacity retention at the 300th cycle with respect to the initial capacity was 67% or less.

In the positive electrode material for lithiumion secondary batteries of the invention, since the amounts of magnetic impurities and water-containing impurities are reduced, a lithium ion secondary battery including an electrode for lithium ion secondary batteries prepared using the positive electrode material for lithium ion secondary batteries has excellent durability and safety, and the discharge capacity and the energy density are high. Thus, the battery can be applied to a next generation secondary battery that is expected to have a higher voltage, higher energy density, higher load characteristics, and higher charge and discharge characteristics. The effects will become significantly larger in the case of a next-generation secondary battery.

What is claimed is:

1. A positive electrode material for lithium ion secondary batteries comprising:
central particles composed of LiFeₓMn_{1-x-y}M_{y}PO₄ (0.05≦x≦1.0, 0≦y≦0.14, wherein M represents at least one element selected from Mg, Ca, Co, Sr, Ba, Ti, Zn, B, Al, Ga, In, Si, Ge, and rare earth elements); and a carbonaceous film that covers surfaces of the central particles,
wherein a specific magnetization is 0.70 emu/g or less, and
an amount of water detected by a Karl Fischer titration method (coulometric titration method) in a temperature range of 100° C. or higher and 250° C. or lower is 8,000 ppm or less.

2. A method of producing a positive electrode material for lithium ion secondary batteries comprising central particles expressed by LiFeₓMn_{1-x-y}M_{y}PO₄ (0.05≦x≦1.0, 0≦y≦0.14, wherein M represents at least one element selected from Mg, Ca, Co, Sr, Ba, Ti, Zn, B, Al, Ga, In, Si, Ge, and rare earth elements), the method comprising:
obtaining a synthesized product which is a positive electrode active material or a precursor of the positive electrode active material by heating a dispersion obtained by dispersing at least a lithium salt, a metal salt including Fe, and a phosphoric acid compound selected from the group consisting of the lithium salt, the metal salt including Fe, a metal salt including Mn, and a compound including the M and the phosphoric acid compound in a dispersion medium in a pressure resistant vessel;
preparing a mixture by adding an auxiliary material including PO₄ and Li to the synthesized product; and
firing the mixture,
wherein in the preparing of the mixture, a molar ratio of Li to PO₄ in the auxiliary material is 0.2 or more and 2.8 or less.

3. The method of producing a positive electrode material for lithium ion secondary batteries according to claim 2,
wherein the amount of PO₄ added is 0.2 parts by mass or more and 4 parts by mass or less with respect to 100 parts by mass of the precursor of the positive electrode active material.

4. A positive electrode for lithium ion secondary batteries comprising:
a current collector; and
a positive electrode mixture layer that is formed on the current collector,
wherein the positive electrode mixture layer comprises the positive electrode material for lithium ion secondary batteries according to claim 1.

5. A lithium ion secondary battery comprising:
the positive electrode for lithium ion secondary batteries according to claim 4.
